(19) United States
(12) Patent Application Publication
(10) Pub. No.: US 2017/0149946 A1
(43) Pub. Date: May 25, 2017

(54) SIMPLIFIED CONNECTION TO AND DISCONNECTION FROM VEHICLE COMPUTING SYSTEMS

(71) Applicant: Ford Global Technologies, LLC, Dearborn, MI (US)

(72) Inventors: Pietro BUTTOLO, Dearborn Heights, MI (US); Stephen Ronald TOKISH, Sylvania, OH (US); James Stewart RANKIN, II, Novi, MI (US); Yifan CHEN, Ann Arbor, MI (US); Stuart C. SALTER, White Lake, MI (US); James J. SURMAN, Clinton Township, MI (US)

(21) Appl. No.: 14/949,121

(22) Filed: Nov. 23, 2015

(51) Int. Cl. H04M 1/60; H04W 76/02; H04W 4/04

(52) U.S. Cl. CPC H04M 1/6091; H04W 4/046; H04W 76/02

(57) ABSTRACT

A location of a personal device of a user may be determined using signal strength information between a wireless transceiver of the personal device and a plurality of components of the vehicle. The personal device may be automatically paired and connected to a feature of the vehicle computing system when the location is a driver seating zone and the personal device is not connected to the feature. The personal device may be automatically disconnected from the feature when the location is not the driver seating zone and the personal device is connected to the feature. Connectivity information between the personal device and the feature may be purged based on one or more criteria.

### TECHNICAL FIELD

Aspects of the disclosure generally relate to simplified connection to and disconnection from vehicle computing systems.

### BACKGROUND

Sales of personal devices, such as smartphones and wearables, continue to increase. Thus, more personal devices are brought by users into the automotive context. Smartphones can already be used in some vehicle models to access a wide range of vehicle information, to start the vehicle, and to open windows and doors. Some wearables are capable of providing real-time navigation information to the driver. Device manufacturers are implementing frameworks to enable a more seamless integration of their brand of personal devices into the driving experience.

### SUMMARY

In a first illustrative embodiment, a system includes a personal device including a wireless transceiver and a processor, programmed to determine a location of the personal device using signal strength information between the wireless transceiver and a plurality of in-vehicle components of a vehicle; connect to a hands-free audio system of the vehicle when the location is a driver seating zone and the personal device is not connected to the audio system, and disconnect from the audio system when the location is not the driver seating zone and the personal device is connected to the audio system.

In a second illustrative embodiment, a method includes determining a personal device is within a driver seating zone using signal strength information between a personal device transceiver and in-vehicle components of a vehicle; receiving connectivity information including an address of a computing system from one of the in-vehicle components located in the driver seating zone; storing the connectivity information to the personal device; and connecting the personal device to the address of the computing system as a driver device.

In a third illustrative embodiment, a system includes components of a vehicle each having a wireless transceiver; and a computing system of the vehicle including a processor programmed to determine a location of a personal device using signal strength information between the personal device and the components; and disconnect the personal device from a driver-specific feature of the computing system when the location is not a driver seating zone and the personal device is connected to the feature.

### BRIEF DESCRIPTION OF THE DRAWINGS

FIG. 1A illustrates an example system including a vehicle having a mesh of in-vehicle components configured to locate and interact with users and personal devices of the users;

FIG. 1B illustrates an example in-vehicle component equipped with a wireless transceiver configured to facilitate detection of and identify proximity of the personal devices;

FIG. 1C illustrates an example in-vehicle component requesting signal strength from other in-vehicle components of the vehicle;

FIG. 2A illustrates an example diagram of multiple users approaching the vehicle;

FIG. 2B illustrates an example diagram of multiple users having entered the vehicle;

FIG. 3 illustrates an example diagram of the in-vehicle components facilitating detection of and identifying proximity of personal devices;

FIG. 4 illustrates an example diagram of the vehicle computing system identifying the personal device as being the primary personal device;

FIG. 5A illustrates an example diagram of the mesh of in-vehicle components used to identify the location of a personal device;

FIG. 5B illustrates an alternate example diagram of the mesh of in-vehicle components used to identify the location of the personal device;

FIG. 6 illustrates an example diagram of updating the primary personal device according to the identified locations of the personal devices;

FIG. 7 illustrates an example diagram of a personal device connected to the vehicle computing system that is outside the vehicle;

FIG. 8 illustrates an example diagram of the mesh of in-vehicle components used to identify the location of the personal device as being outside the vehicle;

FIG. 9 illustrates an example diagram of disconnecting the primary personal device 104 according to the identified locations of the personal devices;

FIG. 10A illustrates an example diagram of the mesh of in-vehicle components used to identify the location of the personal device as having entered the vehicle;

FIG. 10B illustrates an example diagram of connecting the primary personal device according to the personal device as having entered the vehicle;

FIG. 11A illustrates an example diagram of the personal device according to the personal device as having entered the vehicle for the first time;

FIG. 11B illustrates an example diagram of the personal device requesting connectivity information;

FIG. 12A illustrates an example diagram of the personal device receiving connectivity information;

FIG. 12B illustrates an example diagram the personal device connecting to the vehicle computing system using the received connectivity information; and

FIG. 13 illustrates an example process for automated connectivity of a personal device with a vehicle computing system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle computing system, such as an infotainment system, may provide connectivity priority to a favorite or most-recently-connected phone or other personal device. Such a strategy may work well in many cases, but may have undesirable consequences in others. For instance, if a user decides to warm-up a vehicle on a cold day, the computing system may connect to a favorite phone that is not located within the vehicle. Phone calls placed or received while the user is getting ready to leave, but not yet inside the vehicle, may then be routed through the system microphone and speakers instead of through the user's phone. In another scenario, a group of users may take turns as driver, and the driver's phone should be the one connected to the system for sending and receiving phone calls. However, if the favorite or last-connected phone is present, or if a favorite phone happens to be discovered first, the system may remain connected to the same phone through the duration of the trip. Thus, phone calls received by a current driver might not be routed through the hands-free feature of the system, requiring the driver to answer the phone or ignore the call. In yet a further possibility, in a one-use ride-sharing scenario, the need to pair a phone with each different vehicle system for a single use disincentives use of infotainment or other vehicle features.

Vehicle interior modules, such as reading lights or speakers, may be enhanced with a wireless communication interface such as Bluetooth Low Energy (BLE). These enhanced modules of the vehicle interior may be referred to as in-vehicle components. Vehicle occupants may utilize their personal devices to control features of the in-vehicle components over the communications interface. In an example, a vehicle occupant may utilize an application installed to the personal device to turn a reading light on or off or to adjust a volume of a speaker.

The location of the personal device may be determined according to signal strength information between the in-vehicle components and the personal device. This location may include, in which seating zone of the vehicle the personal device is located, as well as whether the personal device is located inside or outside the vehicle. Using the location information, the infotainment system may make improved decisions regarding which phone should be paired to the infotainment system. Moreover, for one-time use scenarios, the system may make use of automated credential provisioning services, thereby improving the user experience for ride-sharing or car-sharing users.

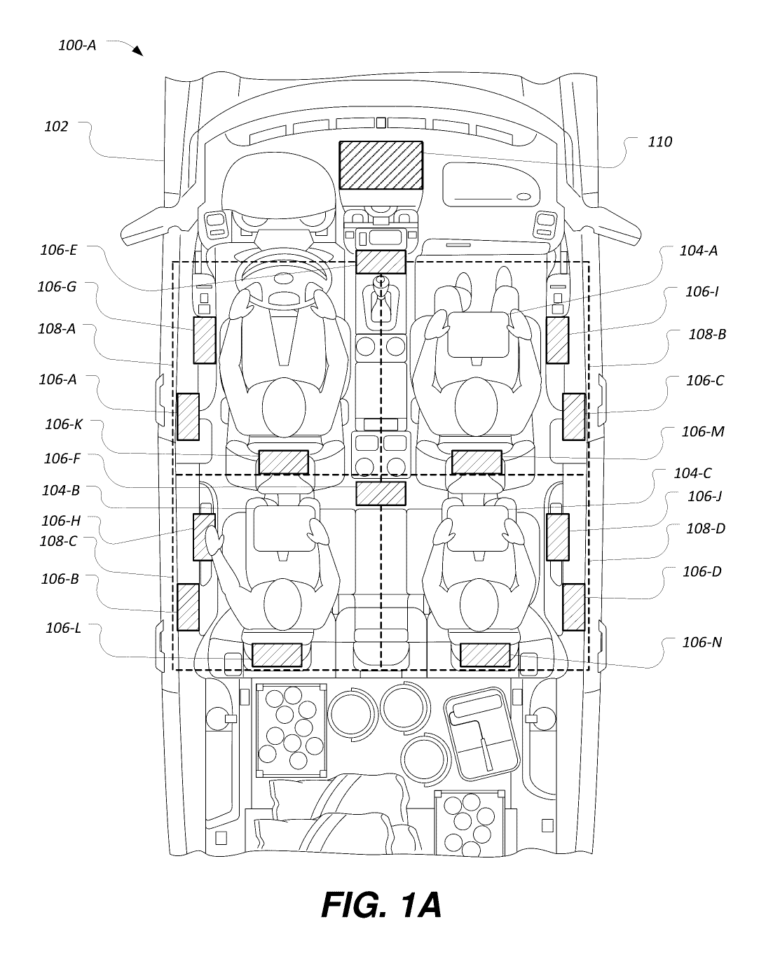

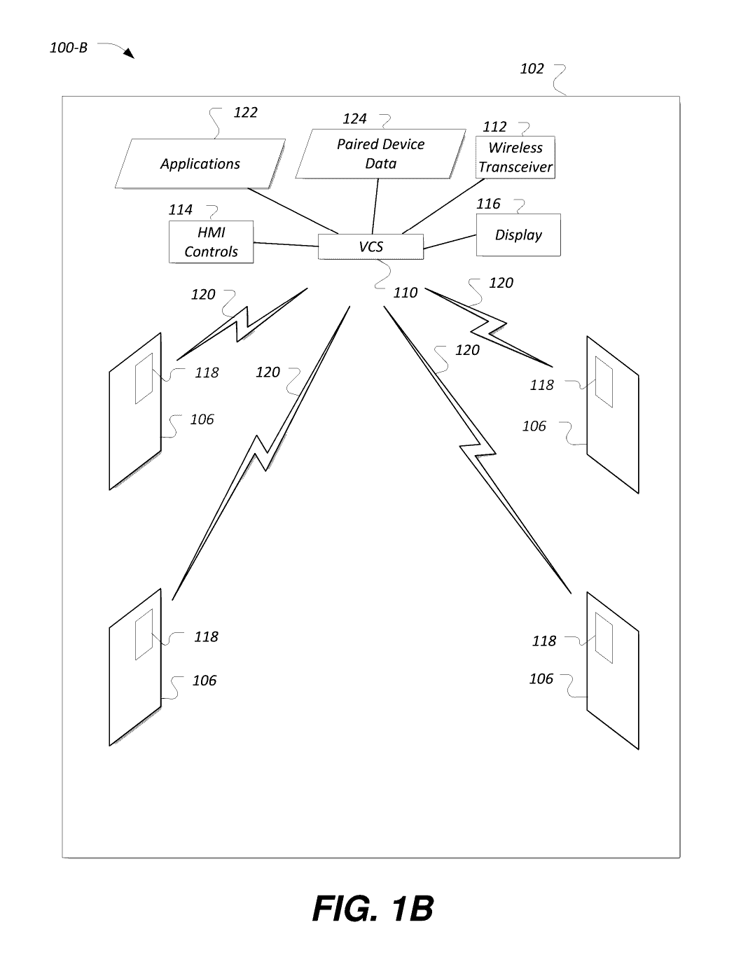

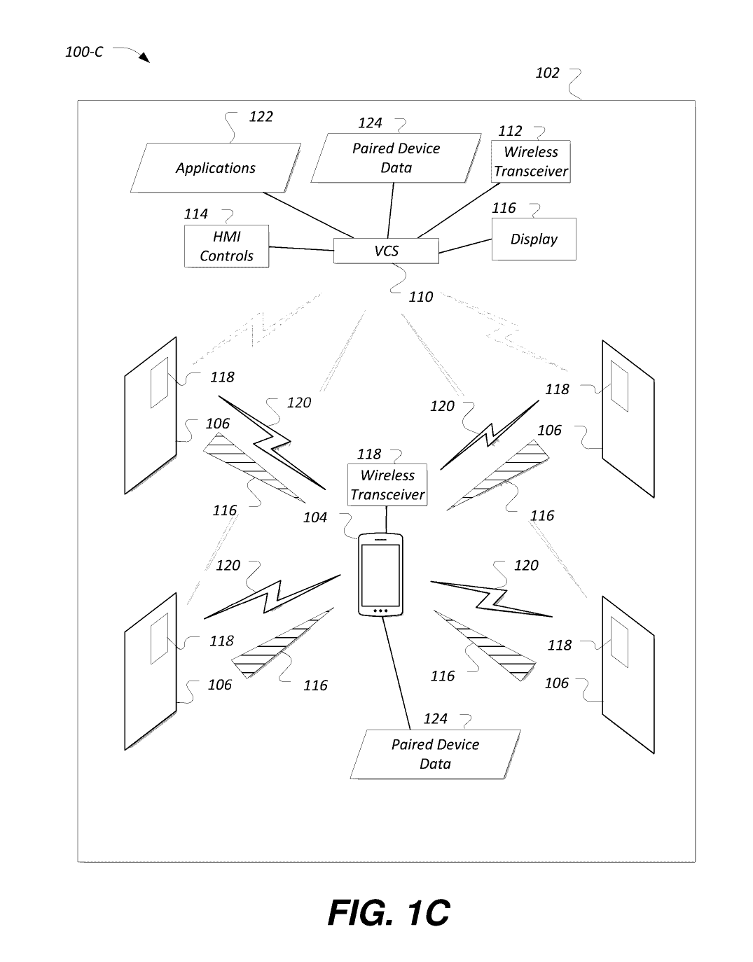

FIG. 1A illustrates an example system 100 including a vehicle 102 having a mesh of in-vehicle components 106 configured to locate and interact with users and personal devices 104 of the users. The system 100 may be configured to allow the users, such as vehicle occupants, to seamlessly interact with the in-vehicle components 106 in the vehicle 102 or with any other framework-enabled vehicle 102. Moreover, the interaction may be performed without requiring the personal devices 104 to have been paired with or be in communication with a head unit or other centralized computing platform of the vehicle 102.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The personal devices 104-A, 104-B and 104-C (collectively 104) may include mobile devices of the users, and/or wearable devices of the users. The mobile devices may be any of various types of portable computing device, such as cellular phones, tablet computers, smart watches, laptop computers, portable music players, or other devices capable of networked communication with other mobile devices. The wearable devices may include, as some non-limiting examples, smartwatches, smart glasses, fitness bands, control rings, or other personal mobility or accessory device designed to be worn and to communicate with the user's mobile device.

The in-vehicle components 106-A through 106-N (collectively 106) may include various elements of the vehicle 102 having user-configurable settings. These in-vehicle components 106 may include, as some examples, overhead light in-vehicle components 106-A through 106-D, climate control in-vehicle components 106-E and 106-F, seat control in-vehicle components 106-G through 106-J, and speaker in-vehicle components 106-K through 106-N. Other examples of in-vehicle components 106 are possible as well, such as rear seat entertainment screens or automated window shades. In many cases, the in-vehicle component 106 may expose controls such as buttons, sliders, and touchscreens that may be used by the user to configure the particular settings of the in-vehicle component 106. As some possibilities, the controls of the in-vehicle component 106 may allow the user to set a lighting level of a light control, set a temperature of a climate control, set a volume and source of audio for a speaker, and set a position of a seat.

The vehicle 102 interior may be divided into multiple zones 108, where each zone 108 may be associated with a seating position within the vehicle 102 interior. For instance, the front row of the illustrated vehicle 102 may include a first zone 108-A associated with the driver seating position, and a second zone 108-B associated with a front passenger seating position. The second row of the illustrated vehicle 102 may include a third zone 108-C associated with a driver-side rear seating position and a fourth zone 108-D associated with a passenger-side rear seating position. Variations on the number and arrangement of zones 108 are possible. For instance, an alternate second row may include an additional fifth zone 108 of a second-row middle seating position (not shown). Four occupants are illustrated as being inside the example vehicle 102, three of whom are using personal devices 104. A driver occupant in the zone 108-A is not using a personal device 104. A front passenger occupant in the zone 108-B is using the personal device 104-A. A rear driver-side passenger occupant in the zone 108-C is using the personal device 104-B. A rear passenger-side passenger occupant in the zone 108-D is using the personal device 104-C.

Each of the various in-vehicle components 106 present in the vehicle 102 interior may be associated with the one or more of the zones 108. As some examples, the in-vehicle components 106 may be associated with the zone 108 in which the respective in-vehicle component 106 is located and/or the one (or more) of the zones 108 that is controlled by the respective in-vehicle component 106. For instance, the light in-vehicle component 106-C accessible by the front passenger may be associated with the second zone 108-B, while the light in-vehicle component 106-D accessible by passenger-side rear may be associated with the fourth zone 108-D. It should be noted that the illustrated portion of the vehicle 102 in FIG. 1A is merely an example, and more, fewer, and/or differently located in-vehicle components 106 and zones 108 may be used.

The vehicle computing system 110 may be configured to provide telematics services to the vehicle 102. These services may include, as some non-limiting possibilities, navigation, turn-by-turn directions, vehicle health reports, local business search, accident reporting, and hands-free calling. In an example, the vehicle computing system 110 may include the SYNC system manufactured by The Ford Motor Company of Dearborn, Mich.

The vehicle computing system 110 may be further configured to communicate with other components of the vehicle 102 via one or more in-vehicle networks. The in-vehicle networks may include one or more of a vehicle controller area network (CAN), an Ethernet network, and a media oriented system transfer (MOST), as some examples. The in-vehicle networks may allow the vehicle computing system 110 to communicate with other vehicle systems, such as a vehicle modem (which may not be present in some configurations), a global positioning system (GPS) module configured to provide current vehicle location and heading information, and various other vehicle controllers.

Referring to FIG. 1B, the vehicle computing system 110 may receive input from human-machine interface (HMI) controls 114 configured to provide for occupant interaction with the vehicle 102. For instance, the vehicle computing system 110 may interface with one or more buttons or other HMI controls 114 configured to invoke functions on the vehicle computing system 110 (e.g., steering wheel audio buttons, a push-to-talk button, instrument panel controls, etc.). The vehicle computing system 110 may also drive or otherwise communicate with one or more displays 116 configured to provide visual output to vehicle occupants. In some cases, the display 116 may be a touch screen further configured to receive user touch input (e.g., operating as an HMI control 114), while in other cases the display 116 may be an output device only, without also having input capabilities.

The vehicle computing system 110 may interface with a wireless transceiver 112 configured to communicate with the personal devices 104 of the vehicle occupants. In an example, the wireless transceiver 112 may include one or more of a BLUETOOTH module, a ZIGBEE transceiver, a Wi-Fi transceiver, an IrDA transceiver, an RFID transceiver, etc.) configured to communicate with compatible wireless transceivers 118 of the personal devices 104.

The personal devices 104 may provide network connectivity to a communications network via a device modem of the personal device 104. The communications network may provide communications services, such as packet-switched network services (e.g., Internet access, VoIP communication services), to devices connected to the communications network. An example of a communications network may include a cellular telephone network. To facilitate the communications over the communications network, personal devices 104 may be associated with unique device identifiers (e.g., mobile device numbers (MDNs), Internet protocol (IP) addresses, BLUETOOTH identifications, etc.) to identify the communications of the personal devices 104 over the communications network. In some cases, occupants of the vehicle 102 or devices having permission to connect to the vehicle computing system 110 may be identified by the vehicle computing system 110 according to paired device data 124 maintained by the vehicle computing system 110. The paired device data 124 may indicate, for example, the unique device identifiers of personal devices 104 previously paired with the vehicle computing system 110 of the vehicle 102, secret information shared between the paired device and the vehicle computing system 110 such as link keys, personal identification numbers (PINs), and/or most recently used or device priority information, such that the vehicle computing system 110 may automatically reconnected to the personal devices 104 referenced in the paired device data 124 without user intervention. The personal devices 104 may similarly maintain paired device data 124, such as secret information shared between the paired device and the vehicle computing system 110 such as link keys and personal identification numbers (PINs).

When a personal device 104 is paired with the vehicle computing system 110 as the primary or driver device, the personal device 104 may allow the vehicle computing system 110 to use the network connectivity of the device modem to communicate over the communications network. Additionally, when paired as the driver device, the personal device 104 may be able to access the HMI control 114 and/or display 116 features of the vehicle computing system 110. However, to avoid driver distraction, input to the personal device 104 display may be disabled when the personal device 104 is paired to the vehicle computing system 110 as the driver device.

Each in-vehicle component 106 may also be equipped with wireless transceivers 118, such that the wireless transceiver 112 of the vehicle computing system 110 may also be able to communicate data with the wireless transceivers 118 of the in-vehicle component 106 over wireless connections 120. Similar to the connections between the vehicle computing system 110 and personal devices 104, the wireless connections 120 may be a BLE connection, but other types of local wireless connection 120 may be utilized as well.

Referring to FIG. 1C, the in-vehicle components 106 may be used to facilitate detection of and identify proximity of the personal devices 104. For example, the distance of the target from a reference can be obtained from a measurement of signal strength 116 over the wireless connection 120 between the wireless transceiver 118 of the in-vehicle component 106 and the wireless transceiver 112 of the personal device 104, or from a time measurement of either arrival (TOA) or difference of arrival (TDOA).

One of the advantages of lateration using signal strength 116 is that it can leverage the already-existing received signal strength indication (RSSI) signal strength 116 information available in many communication protocols. For example, iBeacon uses the RSSI signal strength 116 information available in the Bluetooth Low-Energy (BLE) protocol to infer the distance of a beacon from a personal device 104 (i.e. a target), so that specific events can be triggered as the personal device 104 approaches the beacon. Other implementations expand on the concept, leveraging multiple references to estimate the location of the target. When the distance from three reference beacons are known, the location can be estimated in full (trilateration) from the following equations:

d₁²=(x−x₁)²+(y−y₁)²+(z−z₁)² (1)

d₂²=(x−x₂)²+(y−y₂)²+(z−z₂)²

d₃²=(x−x₃)²+(y−y₃)²+(z−z₃)²

In an example, as shown in FIG. 1C, a mesh of in-vehicle components 106-A through 106-D identifies signal strength 116-A though 116-D between the personal device 104 and each of the respective in-vehicle components 106-A through 106-D. These signal strengths 116 may be provided to the vehicle computing system 110 for processing. As another possibility, these signal strengths 116 may be processed by the personal device 104 having the connections to the in-vehicle components 106. Using the signal strengths 116-A through 116-D, the equations (1) may be used to perform trilateration and locate the personal device 104. As another possibility, the personal device 104 with the highest signal strength 116 to a particular in-vehicle component 106 may be identified as being the personal device 104 within the zone 108 of that in-vehicle component 106:

$$Personal Device = i ⇒ {max}_{i = 1 , n} {RSSI}_{i} \qquad ( 2 )$$

Moreover, based on whether an average of the signal strengths 116 is below a threshold value, the signal strength 116 data may further be used to determine whether the personal device 104 is inside or outside the vehicle 102. Thus, the mesh of in-vehicle components 106 and the personal devices 104 may accordingly be utilized to allow the vehicle computing system 110 to identify in which zone 108, if any, each personal device 104 is located.

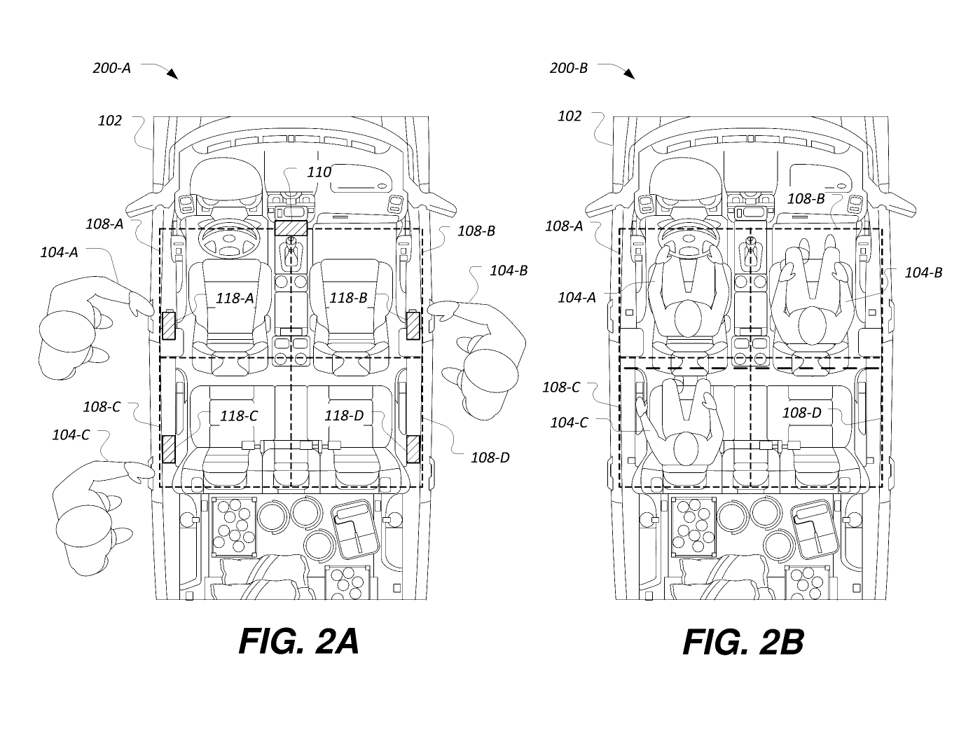

FIG. 2A illustrates an example diagram 200-A of multiple users approaching the vehicle 102. For sake of example, each user is also carrying a personal device 104 that was previously paired with the vehicle computing system 110 (e.g., for which an entry is included in the paired device data 124 of the vehicle computing system 110). As shown, a first user is carrying a personal device 104-A, a second user is carrying a personal device 104-B, and a third user is carrying a personal device 104-C.

FIG. 2B illustrates an example diagram 200-B of multiple users having entered the vehicle 102. As shown, the first user carrying the personal device 104-A is located in the seating zone 108-A, the second user carrying a personal device 104-B is located in the seating zone 108-B, and the third user is carrying a personal device 104-C is located in the seating zone 108-C.

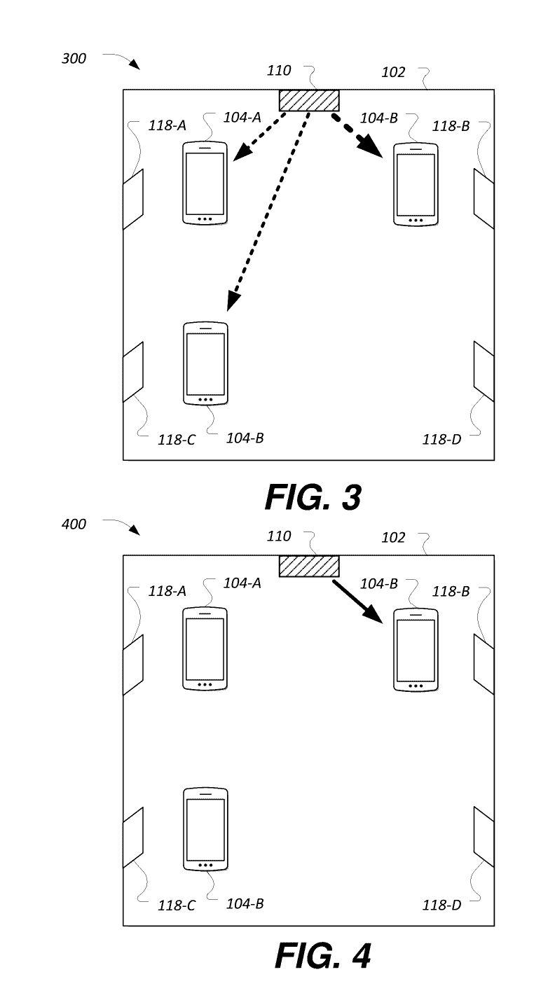

FIG. 3 illustrates an example diagram 300 of the vehicle computing system 110 identifying previously paired personal devices 104 within the vehicle 102. The vehicle computing system 110 may be tasked with determining which of the personal devices 104 should be paired with the vehicle computing system 110 as the primary/driver personal device 104. Continuing with the example of the personal devices 104-A, 104-B, and 104-C having entered the vehicle 102, the vehicle computing system 110 may attempt to connect to previously paired personal devices 104, based on one or more trigger conditions, such as starting the vehicle 102.

Some vehicle computing system 110 may be configured to allow multiple personal devices 104 to connect to the vehicle computing system 110, with one of the personal devices 104 being the primary or driver personal device 104. The primary or driver personal device 104 may be the device with which the vehicle computing system 110 interfaces for mobile calls, text or other messaging, and media playback functions. As shown in the example 400, the personal device 104-B is connected as the primary personal device 104, while the personal devices 104-A and 104-C are connected as non-primary devices.

FIG. 4 illustrates an alternate example diagram 500 of the vehicle computing system 110 identifying the personal device 104-B as being the primary personal device 104. As compared to the vehicle computing system 110 in the example diagram 300, the vehicle computing system 110 in the example diagram 400 is configured to only connect to a single personal device 104, such that once a personal device 104 is paired to the vehicle computing system 110, other personal devices 104 are ignored.

As shown in the diagrams 300 and 400, whether the current driver personal device 104 will be connected as the primary personal device 104 may be arbitrary or based on factors such as which personal device 104 was most recently connected, not based on personal device 104 location.

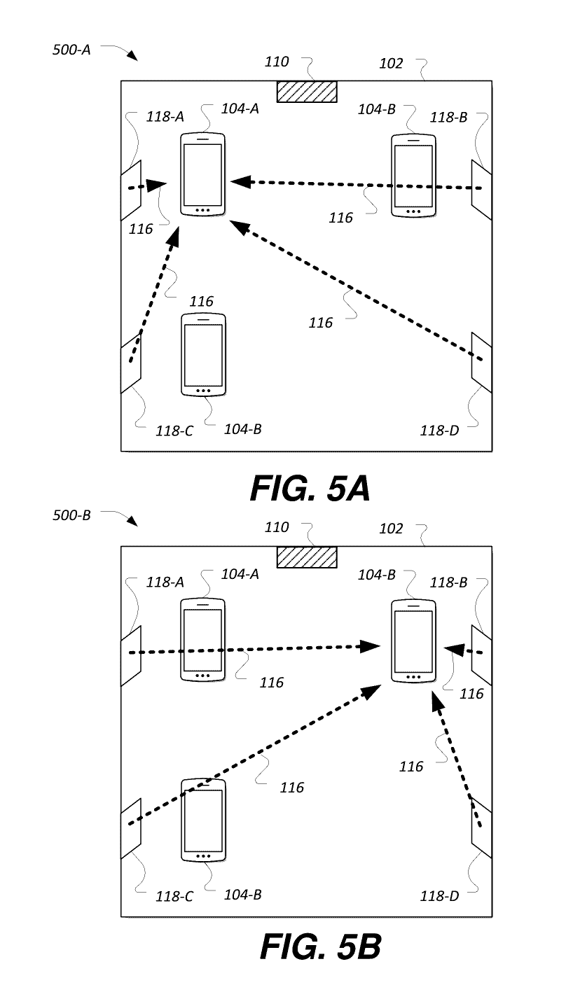

FIG. 5A illustrates an example diagram 500-A of the mesh of in-vehicle components 106 used to identify the location of the personal device 104-A. As shown, the location of the personal device 104-A may be determined according to signal strength 116 information between the in-vehicle components 106 and the personal device 104-A. This location may include in which seating zone 108 of the vehicle the personal device 104-A is located, or whether the personal device 104-A is located outside the vehicle 102. As shown, the personal device 104-A is located in the driver seating zone 108-A.

FIG. 5B illustrates an example diagram 500-B of the mesh of in-vehicle components 106 used to identify the location of the personal device 104-B. As shown, the location of the personal device 104-C may be determined according to signal strength 116 information between the in-vehicle components 106 and the personal device 104-B. As shown, the personal device 104-B is located in the driver seating zone 108-A.

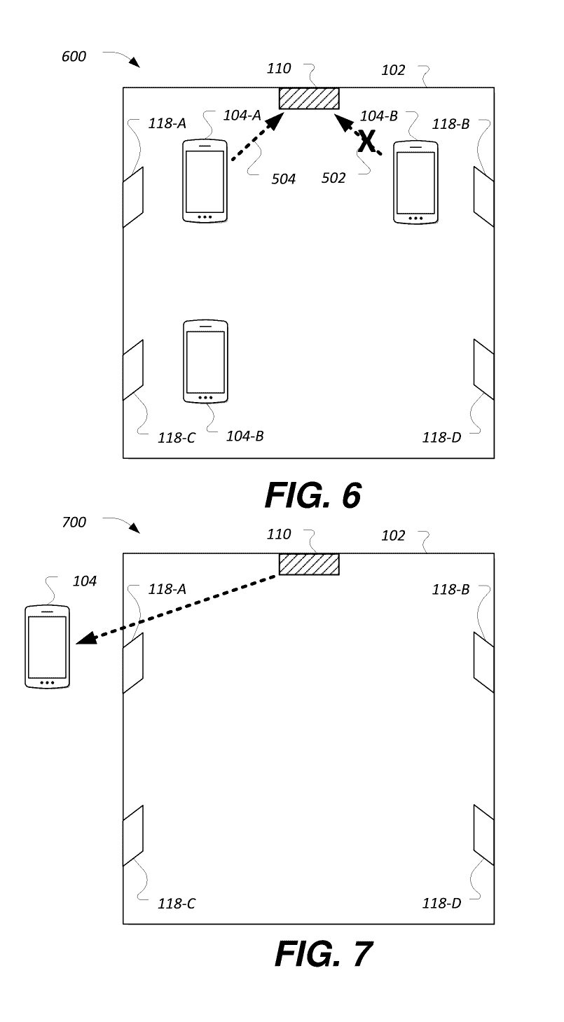

FIG. 6 illustrates an example diagram 600 of updating the primary personal device 104 according to the identified locations of the personal devices 104. Using the location information, the personal devices 104 may make improved decisions regarding which personal device 104 should be paired to the vehicle computing system 110 as the primary personal device 104. For instance, the personal device 104-B may determine that it is not located within the driver zone 108-A but that it is currently paired as the driver personal device 104. Accordingly, the personal device 104-B may issue a disconnect request 502 to the vehicle computing system 110 to un-pair as the primary device. Similarly, the personal device 104-A may determine that it is located within the driver zone 108-A but that it is not currently paired as the driver personal device 104. Accordingly, the personal device 104-A may issue a connection request 504 to the vehicle computing system 110 to pair as the primary device.

FIG. 7 illustrates an example diagram 700 of a personal device 104 connected to the vehicle computing system 110 that is outside the vehicle 102. Such a situation may occur, in an example, if a user decides to remotely start the vehicle 120 to warm-up the vehicle 102 on a particularly cold day. While the vehicle 102 is warming up, the vehicle computing system 110 may connect to a previously-paired personal device 104 that is within proximity to but outside of the vehicle 102. This pairing may include audio pairing of hands-free call connectivity, such that phone calls placed or received while the user is outside the vehicle 102 may be routed through the vehicle computing system 110 microphone and speakers, instead of using the microphone and speaker of the user's personal device 104.

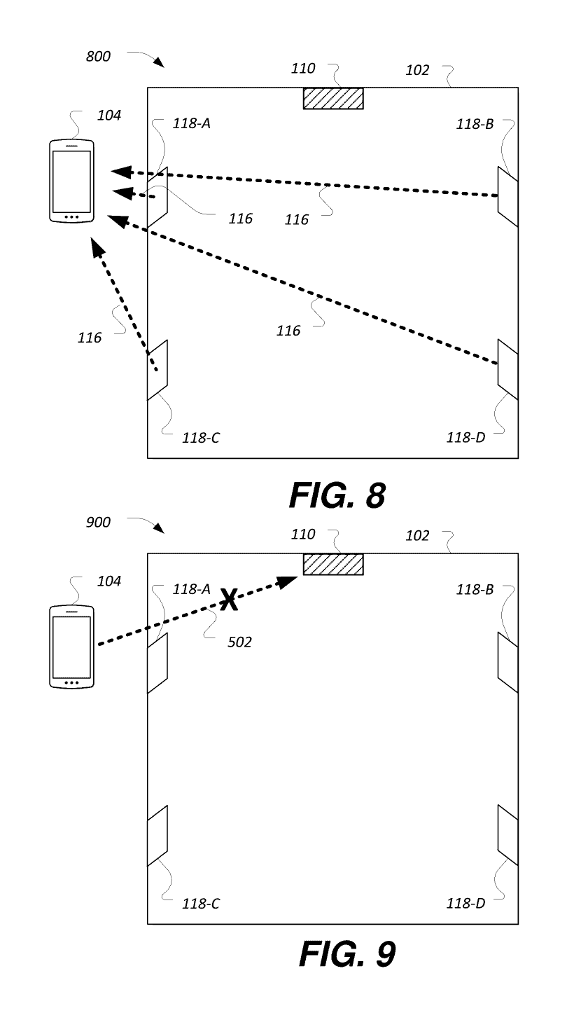

FIG. 8 illustrates an example diagram 800 of the mesh of in-vehicle components 106 used to identify the location of the personal device 104 as being outside the vehicle 102. As shown, the location of the personal device 104 may be determined according to signal strength 116 information between the in-vehicle components 106 and the personal device 104 as being outside the vehicle 102. As one possibility, the personal device 104 may determine that that average of the signal strengths 116 are below a threshold value below which the personal device 104 is most likely outside the vehicle 102.

FIG. 9 illustrates an example diagram 900 of disconnecting the primary personal device 104 according to the identified locations of the personal devices 104. Using the location information, the personal device 104 may determine that it is not located within the vehicle 102 but that it is currently paired as the driver personal device 104. Accordingly, the personal device 104 may issue a disconnect request 502 to the vehicle computing system 110 to un-pair as the primary device.

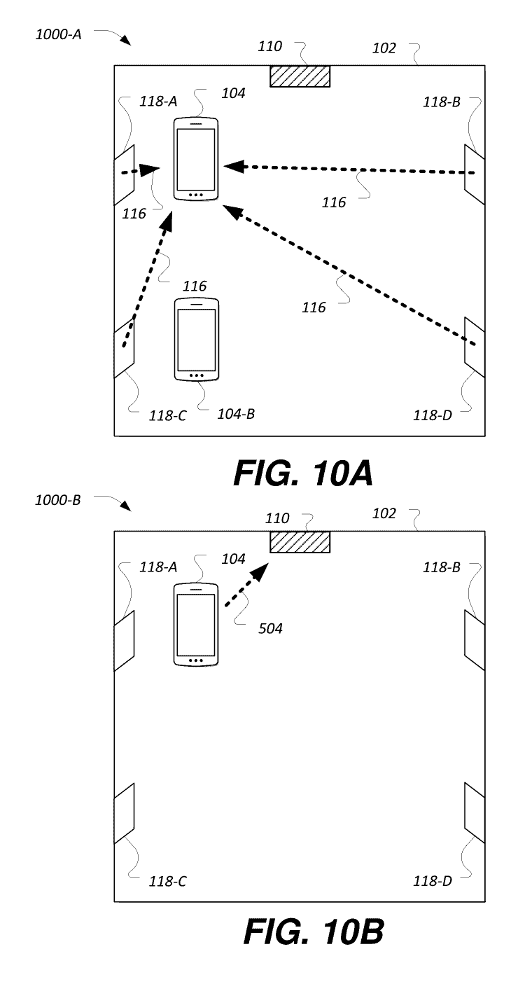

FIG. 10A illustrates an example diagram 1000-A of the mesh of in-vehicle components 106 used to identify the location of the personal device 104 as having entered the vehicle 102. As shown, the location of the personal device 104 may be determined according to signal strength 116 information between the in-vehicle components 106 and the personal device 104 as being outside the vehicle 102.

FIG. 10B illustrates an example diagram 1000-B of connecting the primary personal device 104 according to the personal device 104 as having entered the vehicle 102. As shown, the personal device 104-A may determine that it is located within the driver zone 108-A, but that it is not currently paired as the driver personal device 104. Accordingly, the personal device 104-A may issue a connection request 504 to the vehicle computing system 110 to pair as the primary device.

In a one-use ride-sharing scenario, the need to pair a personal device 104 with each different vehicle computing system 110 each time for a single use disincentive use of such features by riders, who, when busy, may forgo use of the hands-free or other infotainment features altogether. Accordingly, the personal device 104 and in-vehicle components 106 may support providing automated connectivity for the personal device 104 connected as the primary device the first time.

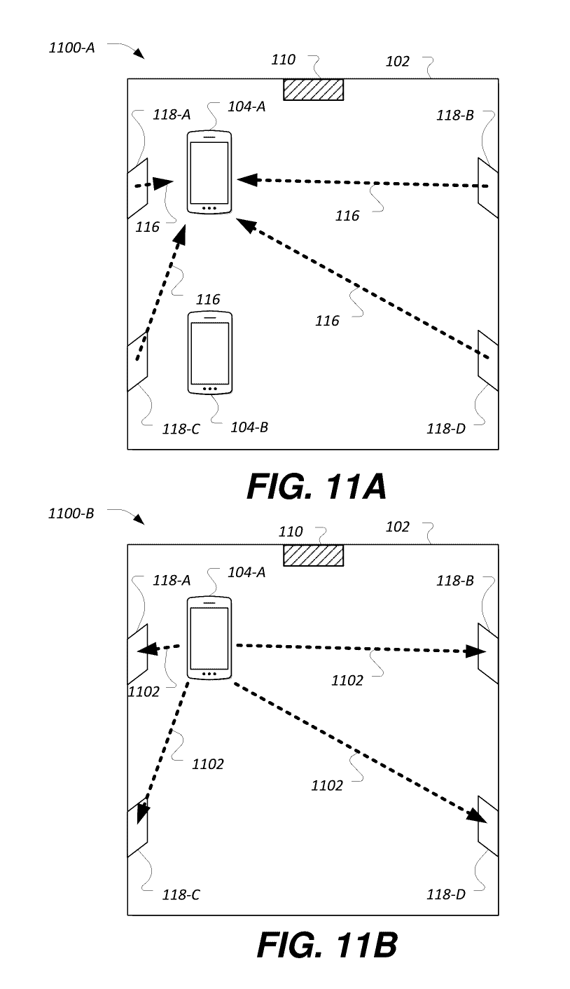

FIG. 11A illustrates an example diagram 1100-A of the personal device 104 having entered the vehicle 102 for the first time. As shown, the location of the personal device 104 may be determined according to signal strength 116 information between the in-vehicle components 106 and the personal device 104 as being in the driver seating zone 108-A.

FIG. 11B illustrates an example diagram 1100-B of the personal device 104 requesting connectivity information. Responsive to determining that the personal device 104 is located in the driver seating zone 108-A, the personal device 104 may issue a connectivity information request 1102 to the in-vehicle components 106 from which the signal strength 116 information to the personal device 104 is determined. The connectivity information request 1102 may be a request for connectivity information to facilitate connection of the personal device 104 to the vehicle computing system 110. As some examples, the connectivity information required to connect to the vehicle computing system 110 may include address information the vehicle computing system 110 (e.g., media access control (MAC) address, internet protocol (IP) address, etc.), and/or access information necessary to access the vehicle computing system 110 (e.g., personal identification number (PIN), certificate, password, key, or other credentials.).

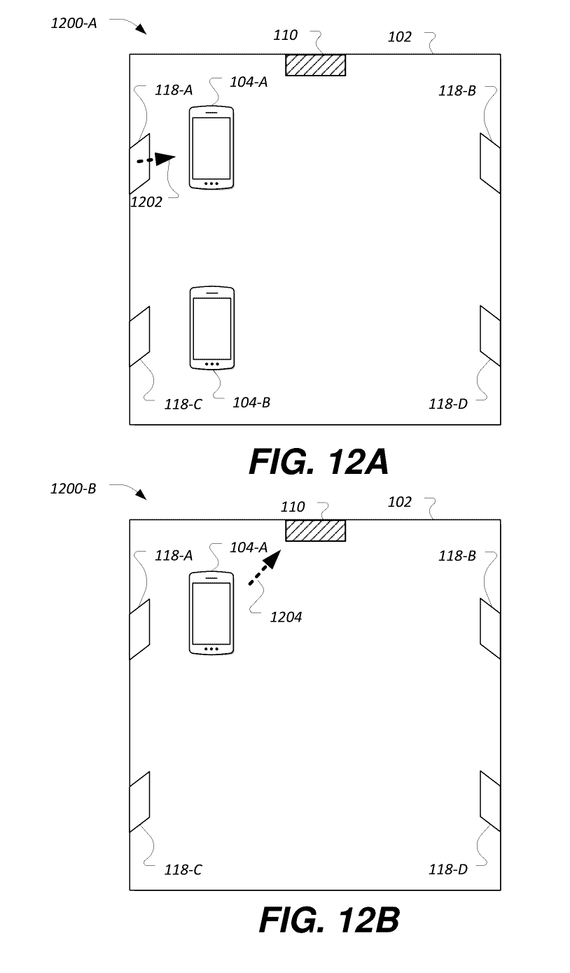

FIG. 12A illustrates an example diagram 1200-A of the personal device 104 receiving connectivity information. In an example, one of the in-vehicle components 106 may be configured to perform the role of responder to connectivity information requests 1102. As one possibility, the driver in-vehicle component 118 may be configured to maintain the connectivity information in a memory of the driver in-vehicle component 118, such as a flash storage device or an EEPROM. In response to the connectivity information request 1102, the driver in-vehicle component 118 sends in a connectivity information response 1202 including the connectivity information to the personal device 104.

FIG. 12B illustrates an example diagram 1200-A of the personal device 104 connecting to the vehicle computing system 110 using the received connectivity information. For instance, responsive to receipt of the connectivity information response 1202, the personal device 104 initiates a pairing request to the address of the vehicle computing system 110. In some examples, the personal device 104 completes the pairing to the vehicle computing system 110 using the received credentials. The vehicle computing system 110 may according add an entry to the paired device data 124 for the now-paired personal device 104. Once added to the paired device data 124, the personal device 104 may initiate a connection request to the vehicle computing system 110.

Thus, the personal device 104 may be able to address one-use driving scenarios by automated pairing with the vehicle computing system 110 when entering the vehicle 102 for the first time. As some other possibilities, the described approach may be used to automatically connect only specific functionality of the personal device 104 to the vehicle computing system 110, such as headset but not audio, or audio but not headset, since the pairing and connection are made programmatically.

For vehicles 102 that are often used for one-time or short duration trips, the paired device data 124 of the vehicle computing system 110 may become filled with entries for personal devices 104 that will likely never re-enter the vehicle 102. Moreover, these entries may include potentially sensitive information, such as MAC addresses of previous customers using a rental vehicle 102. Thus, the vehicle computing system 110 may be configured to purge such entries based on one or more criteria. In an example, the vehicle computing system 110 may be configured to wipe the paired device data 124 at the end of each day, wipe the paired device data 124 once storage for the paired device data 124 is full. As some other possibilities, the vehicle computing system 110 may be configured to remove least recently used paired device data 124 entries when the storage becomes full, full above a threshold amount, at a predetermined time of the day or week, and/or after a predetermined timeout. As some further possibilities, the vehicle computing system 110 may be configured to remove oldest paired device data 124 entries when the storage becomes full, full above a threshold amount, at a predetermined time of the day or week, and/or after a predetermined timeout.

Similarly, personal devices 104 of users who utilize many vehicles 102 may store Bluetooth pairing information for vehicles 102 in which the driver most likely will not drive or ride again. To avoid maintaining the excess pairing information to the personal device 104, if a driver exits the vehicle 102 and does not return to the vehicle 102 within a predetermined time period, the personal device 104 may automatically purge the pairing information of the vehicle computing system 110 of the vehicle 102 if such an option is set in the personal device 104 preferences. Thus, as the user moves to one ride-share to the next, his/her personal phone 104 will not become filled with unnecessary Bluetooth device information.

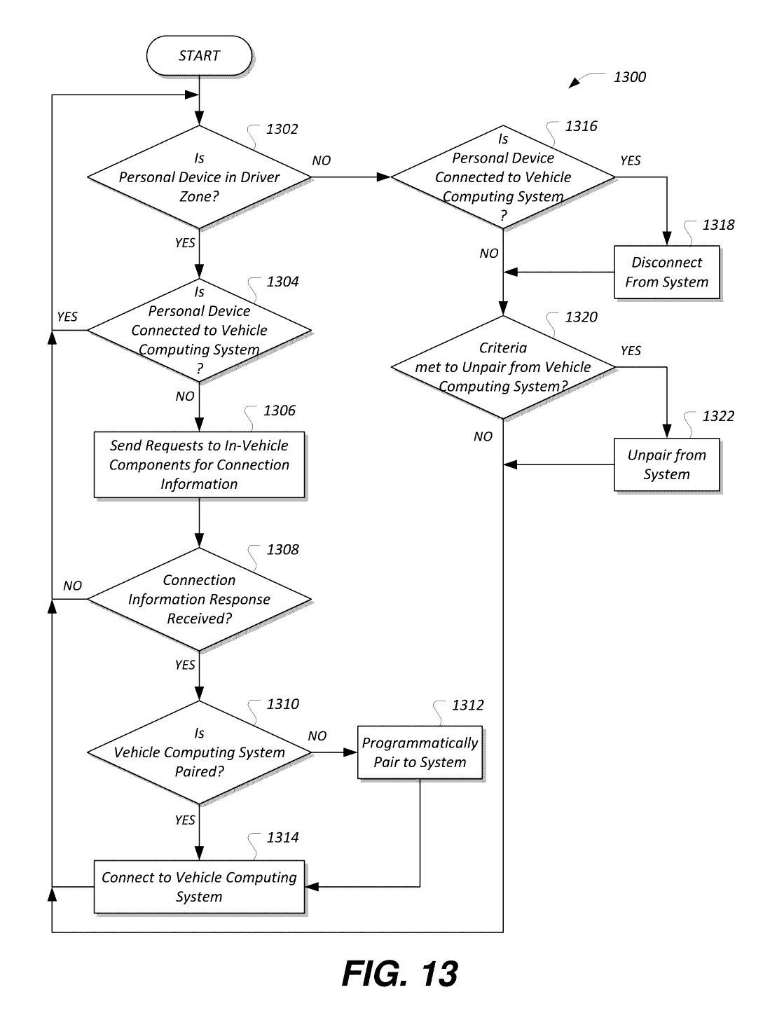

FIG. 13 illustrates an example process 1300 for automated connectivity of a personal device 104 with a vehicle computing system 110. In an example, the process 1300 may be performed by a personal device 104 of a user configured to communicate with the vehicle computing system 110 and in-vehicle components 106 as discussed herein.

At operation 1302, the personal device 104 determines whether the personal device 104 is located within the driver zone 108-A. In an example, the personal device 104 may determine which of the in-vehicle components 106 is closest to the personal device 104 according to signal strength 116 information between the in-vehicle components 106 and the personal device 104. The in-vehicle components 106 may further provide information indicative of the seating zone 108 in which the in-vehicle components 106 are located. The personal device 104 may accordingly determine its location to be that of the seating zone 108 of the in-vehicle components 106 to which the personal device 104 is closest. If the personal device 104 determines that it is located within the driver seating zone 108-A, control passes to operation 1304. Otherwise control passes to operation 1316.

At operation 1304, the personal device 104 determines whether the personal device 104 is connected to the vehicle computing system 110. If a connection is presently established between the personal device 104 and the vehicle computing system 110 and the personal device 104 is located within the driver seating zone 108-A, no change in connected device should be necessary. Accordingly if the personal device 104 is connected to the vehicle computing system 110, control returns to operation 1302. If not, control passes to operation 1306.

At 1306, the personal device 104 sends a connectivity information request 1102 to the in-vehicle components 106. The connectivity information request 1102 may be a request for connectivity information to facilitate connection of the personal device 104 to the vehicle computing system 110.

At operation 1308, the personal device 104 determines whether a connectivity information response 1202 is received from one or more of the in-vehicle components 106. If the connectivity information response 1202 is received, control passes to operation 1310. Otherwise, control returns to operation 1302.

At operation 1310, the personal device 104 determines whether the personal device 104 is paired to the vehicle computing system 110. In an example, the personal device 104 may access pairing information 124 stored to the personal device 104 to determine whether the pairing information 124 includes an entry for the vehicle computing system 110. If no entry is located for the vehicle computing system 110, control passes to operation 1312. If the entry is located, control passes to operation 1314.

At 1312, the personal device 104 programmatically pairs to the vehicle computing system 110. For example, the personal device 104 may pair to the vehicle computing system 110 using the address and credential information included in the connectivity information response 1202. The vehicle computing system 110 may according add an entry to the paired device data 124 for the now-paired personal device 104. Once added to the paired device data 124 (or if the entry already exists), the personal device 104 may initiate a connection request to the vehicle computing system 110 at operation 1314. After operation 1314, control passes to operation 1302.

At operation 1316, the personal device 104 determines whether the personal device 104 is connected to the vehicle computing system 110. If a connection is presently established between the personal device 104 and the vehicle computing system 110 and the personal device 104 is located within the driver seating zone 108-A, a change in connected device may be necessary. Accordingly if the personal device 104 is connected to the vehicle computing system 110, control passes to operation 1318 in which the personal device 104 disconnects from the vehicle computing system 110. If not or after disconnection, control passes to operation 1320.

At 1320, the personal device 104 determines whether criteria are met to un-pair the personal device 104 from the vehicle computing system 110. In an example, if a driver exits the vehicle 102 and does not return to the vehicle 102 within a predetermined time period, the personal device 104 may automatically purge the pairing information of the vehicle computing system 110 of the vehicle 102 if such an option is set in the personal device 104 preferences.

At operation 1322, the personal device 104 un-pairs from the vehicle computing system 110. Accordingly the entry in the paired device data 124 of the personal device 104 for the vehicle computing system 110 may be removed. After operation 1322, control returns to operation 1302.

Computing devices described herein, such as the personal devices 104, in-vehicle components 106, and vehicle computing system 110, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a personal device including
a wireless transceiver; and
a processor, programmed to
determine a location of the personal device using signal strength information between the wireless transceiver and a plurality of in-vehicle components of a vehicle,
connect to a hands-free audio system of the vehicle when the location is a driver seating zone and the personal device is not connected to the audio system, and
disconnect from the audio system when the location is not the driver seating zone and the personal device is connected to the audio system.

2. The system of claim 1, wherein the processor is further programmed to:
request connectivity information from the plurality of in-vehicle components, the connectivity information including at least one of a network address of the audio system or a credential for connection to the audio system; and
responsive to receiving the connectivity information from at least one of the plurality of in-vehicle components, programmatically connect to the audio system using the connectivity information.

3. The system of claim 1, wherein the personal device further includes a memory configured to store paired device data, and the processor is further programmed to, when a predetermined timeout period has expired since use of an entry of the paired device data corresponding to the audio system, purge the entry from the paired device data.

4. The system of claim 1, wherein the plurality of in-vehicle components of the vehicle include overhead lights located in a passenger cabin of the vehicle.

5. The system of claim 1, wherein the personal device is a mobile phone.

6. A method comprising:
determining a personal device is within a driver seating zone using signal strength information between a personal device transceiver and in-vehicle components of a vehicle;
receiving connectivity information including an address of a computing system from one of the in-vehicle components located in the driver seating zone;
storing the connectivity information to the personal device; and
connecting the personal device to the address of the computing system as a driver device.

7. The method of claim 6, wherein the computing system is an infotainment system, and the connecting includes connecting to hands-free audio functionality of the infotainment system.

8. The method of claim 7, wherein the personal device is a mobile phone, and further comprising routing a telephone call through the hands-free audio functionality of the infotainment system.

9. The method of claim 7, wherein the connectivity information further includes one or more credentials for connecting to the infotainment system, and further comprising authorizing the personal device with the computing system using the one or more credentials.

10. The method of claim 6, wherein the in-vehicle components of the vehicle include overhead lights located in a passenger cabin of the vehicle, each of the overhead lights being located in a different seating zone of the vehicle.

11. The method of claim 6, further comprising automatically deleting the connectivity information from the personal device in response to expiration of a predetermined timeout period after disconnection of the personal device from the computing system.

12. The method of claim 6, further comprising deleting the connectivity information from the personal device in response to the personal device being set into a single-use pairing mode, and the personal device being disconnected from the computing system.

13. A system comprising:
components of a vehicle each having a wireless transceiver; and
a computing system of the vehicle including a processor programmed to
determine a location of a personal device using signal strength information between the personal device and the components; and
disconnect the personal device from a driver-specific feature of the computing system when the location is not a driver seating zone and the personal device is connected to the feature.

14. The system of claim 13, wherein the processor is further programmed to:
determine a second location of a second personal device using strength information between the wireless transceiver and the components of the vehicle; and
connect the second personal device to the feature of the computing system when the second location is the driver seating zone and the second personal device is not connected to the feature.

15. The system of claim 13, wherein the feature includes a hands-free audio feature.

16. The system of claim 15, and wherein the hands-free audio feature includes a speaker inside a cabin of the vehicle to provide audio output to the cabin, and a microphone inside the cabin to receive audio input from the cabin.

17. The system of claim 13, wherein the computing system further includes a memory configured to store paired device data, and the processor is further programmed to periodically purge the paired device data from the memory when the computing system is configured for use as a ride-share vehicle.

18. The system of claim 13, wherein the processor is further programmed to determine the location of the personal device responsive to the vehicle being started remotely.
